(19) United States
(12) Patent Application Publication
(10) Pub. No.: US 2022/0393747 A1
(43) Pub. Date: Dec. 8, 2022

(54) COMMUNICATION DEVICE AND COMMUNICATION METHOD

(71) Applicant: FUJITSU LIMITED, Kawasaki-shi (JP)

(72) Inventor: Shoichi Shiba, Atsugi (JP)

(73) Assignee: FUJITSU LIMITED, Kawasaki-shi (JP)

(21) Appl. No.: 17/689,033

(22) Filed: Mar. 8, 2022

(30) Foreign Application Priority Data
Jun. 2, 2021 (JP) 2021-093249

(51) Int. Cl. H04B 7/06; H04B 7/0408

(52) U.S. Cl. CPC H04B 7/0695; H04B 7/0617; H04B 7/0408

(57) ABSTRACT

A communication device configured to form a plurality of beams for a plurality of beam IDs and communicate by radio with a terminal located on a site, includes a storage unit that stores therein beam control information related to a beam width of each of the plurality of beams radiated for each of the beam IDs from an antenna; and a beam controller configured to perform beam control by the beam width for each of the beam IDs, based on the beam control information.

### CROSS REFERENCE TO RELATED APPLICATIONS

This application is based upon and claims the benefit of priority of the prior Japanese Patent Application No. 2021-093249, filed on Jun. 2, 2021, the entire contents of which are incorporated herein by reference.

### FIELD

Embodiments discussed herein relate to a communication device and a communication method.

### BACKGROUND

In the 5G communication scheme, a radio unit (RU) device a performs beam selection (beamforming) using beam IDs and thereby, performs radio communication with a terminal. The beam IDs are arranged in a combination of a horizontal direction (azimuth) and a vertical direction (elevation) from the perspective of the RU.

As for beam techniques for radio waves, for example, according to one technique, a vertical beam width of an antenna is set based on the installation height, area radius, vertical beam width, and tilt angle, so that a predetermined electric field intensity is obtained at any location in an area. According to another technique, plural beams whose tilt angles differ from each other are output and, for plural cells each formed as a sector in a vertical direction, the coverage area of each cell is varied by controlling a vertical plane beam width or transmission power according to a distribution of user terminals. According to a further technique, a sensor is disposed on a communication device such as for an access point and the transmission power and/or the directivity of an antenna are/is varied corresponding to changes in the installation state. According to yet another technique, a variable phase shifter and a synthesizer are disposed on a base station and beams are directed to a hot spot. For examples of such techniques, refer to Japanese Laid-Open Patent Publication No. 2008-154278, Japanese Laid-Open Patent Publication No. 2013-211716, Japanese Laid-Open Patent Publication No. 2009-077117, and Japanese Laid-Open Patent Publication No. 2018-110380.

### SUMMARY

According to an aspect of an embodiment, a communication device configured to form a plurality of beams for a plurality of beam IDs and communicate by radio with a terminal located on a site, includes a storage unit that stores therein beam control information related to a beam width of each of the plurality of beams radiated for each of the beam IDs from an antenna; and a beam controller configured to perform beam control by the beam width for each of the beam IDs, based on the beam control information.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a side view depicting an installation state of a communication device.

FIG. 1B is a view depicting beam widths of the communication device.

FIG. 1C is a view depicting coverage areas of the communication device.

FIG. 2 is a view depicting an example of an overall configuration of a communication system that includes the communication device.

FIG. 3 is a view depicting an example of an overall configuration of the communication system that includes the communication device according to a first embodiment.

FIG. 4 is a view depicting an example of a hardware configuration related to beam control of the communication device.

FIG. 5A is a side view depicting an installation example of the communication device.

FIG. 5B is a side view depicting an installation example of the communication device.

FIG. 6A is a planar view depicting an antenna array of the communication device.

FIG. 6B is a view depicting an example of beam width control of the communication device.

FIG. 7A is an explanatory view of information related to the beam control of the communication device.

FIG. 7B is an explanatory view of the information related to the beam control of the communication device.

FIG. 8 is a flowchart depicting an example of beam control of the communication device according to the first embodiment.

FIG. 9 is a view depicting an example of an overall configuration of the communication system that includes the communication device according to a second embodiment.

FIG. 10 is a sequence diagram depicting an example of the beam control of the communication device according to the second embodiment.

FIG. 11A is an explanatory view of coverage areas of a conventional communication device for comparison.

FIG. 11B is an explanatory view of the coverage areas of the conventional communication device for comparison.

FIG. 11C is an explanatory view of the coverage areas of the conventional communication device for comparison.

FIG. 12 is a view depicting an example of actual beam projection shapes.

### DESCRIPTION OF THE INVENTION

First, problems associated with the conventional techniques are described. Coverage areas of each area vary due to installation heights and tilt angles differing depending on the installation environment of the antennas. In a case in which an RU is disposed on an actual site, even when beams of the beam IDs are radiated with a constant width, the coverage areas projected onto a site (corresponds to the ground surface) are different among the beam IDs.

Therefore, for beam IDs whose coverage areas are each small, frequent switching among the beam IDs occurs due to the movement of terminals (user equipment (UE)) and throughput is thereby reduced. On the other hand, for beam IDs whose coverage areas are each large, many terminals are positioned in each of the coverage areas and are simultaneously connected, whereby interference occurs, and throughput is thereby reduced.

Embodiments of a communication device and a communication method of the disclosure are described below in detail with reference to the drawings.

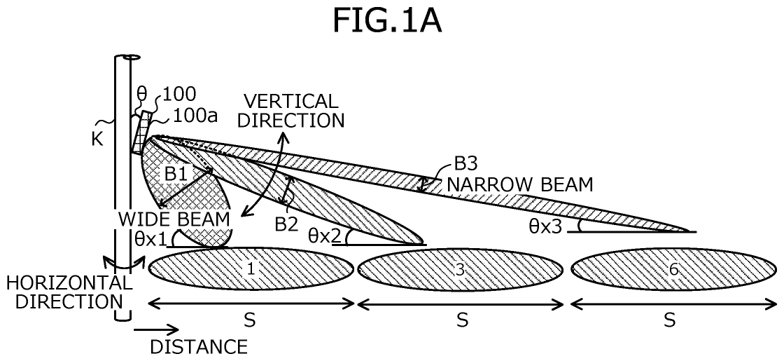

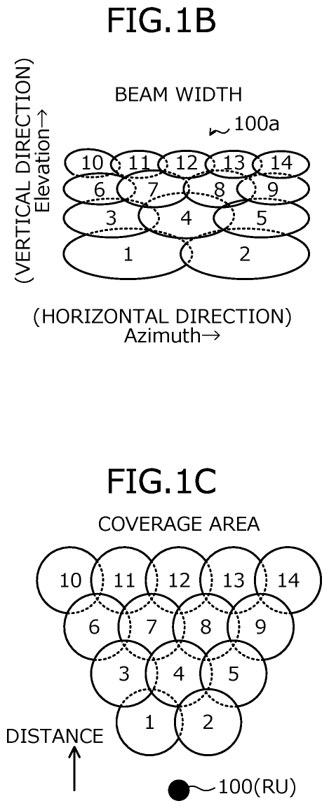

FIGS. 1A, 1B, and 1C are explanatory views of coverage areas of a communication device according to the present invention. For example, a communication device 100 is an RU device of a base station that performs beamforming by a 5G communication scheme to thereby communicate with a terminal.

Herein, description is given assuming that the communication device 100 is disposed on a structure K under installation conditions such as, for example, installation at a predetermined angle (a tilt angle) θ relative to the structure K that has a predetermined length in a vertical direction from a site, and beams being obliquely projected onto the site that is horizontal. The installation conditions of the communication device 100 vary according to installation position. For example, the communication device 100 is disposed at different installation heights from the site (the ground surface) and has at different angles θ of beam radiation according to the installation environment thereof.

FIG. 1A is a side view depicting the installation state of the communication device, the communication device 100 variably controlling the beam width for each of plural beam IDs corresponding to different installation conditions such that an appropriate coverage area is established on the site (the ground surface) for each of the beam IDs. In FIGS. 1A, 1B, and 1C, the beam IDs are numbered for convenience.

FIG. 1B is a view depicting the beam widths of the communication device 100 and FIG. 1C is a view depicting the coverage areas of the communication device 100. FIG. 1B depicts a plane corresponding to a radiation surface 100a of an antenna of the communication device 100, with a horizontal axis representing the horizontal direction of the antenna and a vertical axis representing the vertical direction of the antenna. FIG. 1C corresponds to a top view of the site as seen from above.

As depicted in FIG. 1B, the communication device 100 scans and radiates beams of plural, that is, n beam IDs (IDs: 1 to n). For a beam width B of a beam radiated from the radiation surface 100a of the antenna, the communication device 100 increases the beam width B of a beam associated with a beam ID and directed to a portion of the site located close to the communication device 100, corresponding to the angle θ of the communication device 100. On the other hand, the communication device 100 decreases (reduces) the beam width of a beam associated with a beam ID and directed to a portion of the site, the farther the portion is from the communication device 100.

For example, the communication device 100 maximizes the beam widths of beams that are associated with the beam IDs 1 and 2 and directed to portions of the site located closest to the communication device 100, and minimizes the beam widths of beams that are associated with the beam IDs 10 to 14 and directed to portions of the site located farthest from the communication device 100. For the beam width in the vertical direction, the communication device 100 performs control so that the closer a beam is to the communication device 100, the wider the beam width thereof is and the farther a beam is from the communication device 100 that narrower the beam width is.

While details are described hereinafter, in a storage unit, the communication device 100 retains, according to beam IDs, beam control information related to the beam widths of the beams radiated by the antenna and retains, according to angles θ of the communication device 100, correction information (a beam ID set). The communication device 100 uses, as the control information, the correction information (the beam ID set) that is for correcting, for each angle, the beam widths associated with the beam IDs. The communication device 100 determines the beam widths for the beam IDs using the beam ID set that corresponds to the angle of the communication device 100. The minimum width of a beam is determined according to the RF frequency and the antenna aperture of the communication device 100.

As depicted in FIG. 1C, the communication device 100 may thereby cause all the coverage areas of beams associated with the beam IDs 1 to 14 to be equal to one another on the site even when the communication device 100 is disposed at an angle.

As depicted in FIGS. 1A and 1C, the communication device 100 sets the coverage area of the beam ID 1 projected onto a portion of the site to be a predetermined coverage area S by maximizing the beam width B (to a beam width B1) of the beam ID 1 directed to the portion of the site that is closest to the communication device 100. The communication device 100 further causes the coverage areas of beams associated with the beam IDs 3 and 6 projected onto portions of the site to each be the predetermined coverage area S by reducing the beam widths B (to beam widths B2 and B3) for the beam IDs 3 and 6 to a greater extent the farther the portions thereof are from the communication device 100.

As for the beam width for each of the beam IDs, the projection angle θx of the beam projected onto a portion of the site (the ground surface) is gentler the greater the distance from the communication device 100 to the portion is. In the example depicted in FIG. 1A, the projection angle θx1 of the beam associated with the beam ID 1 and projected onto a portion of the site located closest to the communication device 100 is largest. The projection angle θx3 of the beam associated with the beam ID 3 and projected onto a portion of the site located farthest from the communication device 100 is smallest. The projection angle θx2 of beam associated with the intermediate beam ID 2 is an angle between θx1 and θx3. Taking into consideration the projection angle θx of the beam, for each distance from the communication device 100, the communication device 100 sets the beam widths so that the coverage areas S of all the beams associated with the beam IDs 1 to 14 and projected onto the site are equal to each other as depicted in FIG. 1C.

The communication device 100 may set the transmission power (effective radiated power, or equivalent isotropic radiated power (EIRP)) to be lower for a beam ID the closer the coverage area thereof is to the communication device 100, in the vertical direction. The power in the coverage area of each of n beam IDs 1 to n may be equalized by controlling the transmission power in addition to the above control for the beam width.

The communication device 100 may dynamically vary the coverage areas of the beams associated with the beam IDs 1 to n on the site. For example, the installation angle θ of the communication device 100 is changed to a different angle by a manual operation or automatically by an attitude control device depending on crowd fluctuations according to date and time, etc. The number of the terminals accommodated in each of the coverage areas of the beams associated with the beam IDs 1 to n may thereby become close to a constant number corresponding to the traffic that fluctuates according to the date, the time of day, etc.

In this manner, according to the communication device 100 of the embodiment, the coverage areas may each be suitably set so as to equalize the coverage areas on the site, among the n beam IDs, and a problem such as degradation of the throughput may be suppressed.

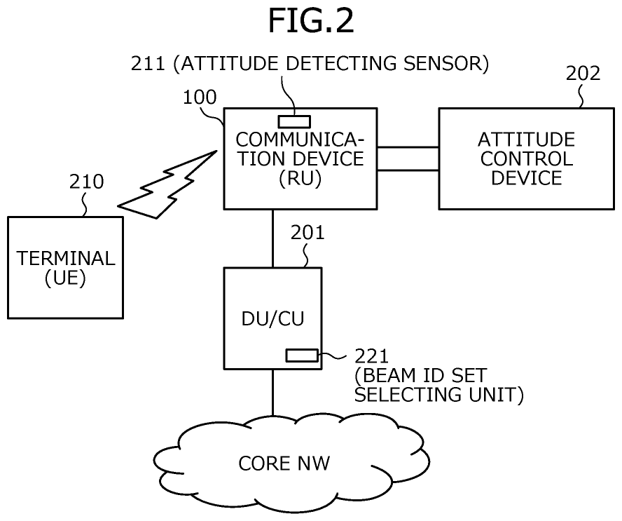

FIG. 2 is a view depicting an example of an overall configuration of a communication system that includes the communication device. The communication device (RU) 100 of the embodiment performs radio communication with a terminal (UE) 210. The terminal 210 moves freely about the above site.

The communication device 100 is connected to a DU/CU 201 and a core network (NW). “DU” is an abbreviation of “distributed unit” and “CU” is an abbreviation of “central unit”. The DU/CU 201 is disposed in, for example, a station building of a communication service provider, and controls communication between the communication device 100 and the core NW.

With regard to the installation height and attitude such as the angle of beam radiation, the communication device 100 may have a configuration such as a first configuration example or a second configuration example as follows. In the first configuration example, a device detects the attitude of the communication device 100, and variably controls the beam widths (a first embodiment). In the second configuration example, an attitude control device 202 is disposed separately from the communication device 100 and variably controls the attitude of the communication device 100 (a second embodiment described later). The attitude control device is also referred to as “remote tilting and steering”.

For example, in the first configuration example, an attitude detecting sensor 211 is disposed in the communication device 100 so that the communication device 100 autonomously detects the attitude thereof. The communication device 100 performs beam control according to the detected attitude. In this beam control, the communication device 100 retains according to angle (corresponds to “according to distance”), n beam IDs as beam ID sets from the communication device 100, and performs the beam width control using the beam ID set that corresponds to a particular angle.

In the second configuration example, the attitude control device 202 freely drives the attitude (such as, for example, the angle) of the communication device 100 and detects the attitude (such as, for example, the angle) of the communication device 100 according to the driving state. The attitude control device 202 outputs information related to the detected attitude (the angle) to the DU/CU 201. The DU/CU 201 includes a beam ID set selecting unit 221 that selects a beam ID set according to the attitude, the beam ID set selecting unit 221 instructing the communication device 100 about the information related to the beam ID set that corresponds to the attitude of the communication device 100. The communication device 100 thereby performs the beam width control on the basis of the beam ID set according to the attitude.

In the second configuration example, the attitude detecting sensor 211 described in the first configuration example may also be used. In this case, the DU/CU 201 selects a beam ID set based on the information related to the attitude of the communication device 100 detected by the attitude detecting sensor 211.

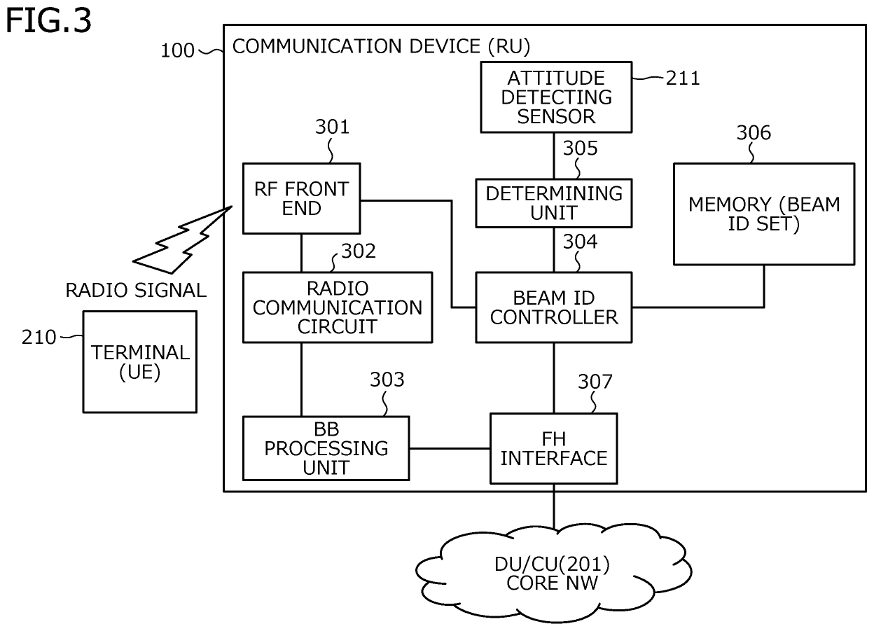

FIG. 3 is a view depicting an example of an overall configuration of the communication system that includes the communication device according to the first embodiment. FIG. 3 mainly depicts internal functions of the communication device 100 of the first configuration example depicted in FIG. 2.

The communication device 100 includes an RF front end 301, a radio communication circuit 302, a baseband (BB) processing unit 303, a beam ID controller 304, the attitude detecting sensor 211, a determining unit 305, a memory 306, and an FH interface 307.

The RF front end 301 is connected to the radio communication circuit 302, and performs high frequency (radio) signal processing to execute radio communication with the terminal 210 through the non-depicted antenna of the communication device 100. The RF front end 301 includes a non-depicted beam forming integrated circuit (BFIC) that performs radio communication (transmission and reception of radio waves) using a predetermined beam width that corresponds to the beam ID set input thereto from the beam ID controller 304. “BFIC” is an abbreviation of “beam forming IC”. The antenna includes plural, that is, n antenna arrays and the BFIC controls the beam width for the horizontal direction (Azimuth) for each of the beam IDs by synthesis processing of the beam directions among the n antenna arrays.

The radio communication circuit 302 is connected to the RF front end 301 and the BB processing unit 303, and performs conversion processing for data and radio signals transmitted and/or received. The radio communication circuit 302 outputs, to the BB processing unit 303, a received radio signal output from the RF front end 301, and outputs, to the RF front end 301, a transmission baseband signal (data) output from the BB processing unit 303.

The BB processing unit 303 is connected to the radio communication circuit 302 and the FH interface 307, and performs baseband processing for data that is transmitted and/or received. The BB processing unit 303 outputs, to the radio communication circuit 302, transmission data input thereto from the core NW side through the FH interface 307 and converts into data, a received signal input thereto from the radio communication circuit 302, and outputs the converted data to the FH interface 307.

The FH interface 307 is used as an example of a communication interface between the communication device 100 and the core NW side. “FH” is an abbreviation of “front haul”.

The attitude detecting sensor 211 senses the attitude (such as, for example, the angle) of the communication device 100. The communication device 100 is fitted to a fixed object such as a pole or a column disposed on an architectural structure such as a building, or a tower, or the like, and is disposed so that an antenna surface thereof is at a predetermined angle and directed toward the site (the ground surface). The attitude detecting sensor 211 includes, for example, a gyroscope and an encoder, and detects the angle of incline relative to a vertical pole, a vertical column, or the like.

The determining unit 305 detects the attitude (such as, for example, the angle) of the communication device 100 sensed by the attitude detecting sensor 211 and outputs the detected angle to the beam ID controller 304.

The memory 306 stores therein the beam control information related to the beam width of the beam radiated by the antenna for each of the beam IDs, and the beam ID sets (correction information). For example, each beam ID set is correction values for the gain/the phase, that correspond to the attitude (such as, for example, the angle) of the communication device 100. While details are described later, the memory 306 stores therein calibration values to calibrate the gain/the phase of the plural antenna arrays, and the beam ID sets according to the angle of the communication device 100. For example, the beam ID set includes the correction values for the gain/the phase for each angle. The calibration values stored in the memory 306 are corrected using the correction values that correspond to the angle, whereby the coverage areas associated with the beam IDs may be set to be constant on the site.

The beam ID controller 304 is connected to the determining unit 305, the FH interface 307, the memory 306, and the RF front end 301. The beam ID controller 304 refers to the memory 306 and selects the beam ID set that corresponds to the attitude (the angle) of the communication device 100 determined by the determining unit 305. The beam ID controller 304 outputs the information related to the selected beam ID set to the RF front end 301.

The beam ID set corresponding to the attitude (such as, for example, the angle) of the communication device 100 is input to the RF front end 301 by the beam ID controller 304. The RF front end 301, thereby, performs radio communication (and radio communication based on data input and output by the FH interface 307) with the terminal 210. When this radio communication is executed, the RF front end 301 uses the beam ID set that corresponds to the angle of the communication device 100 and performs the beam width control so that the coverage areas associated with the beam IDs are set to be constant.

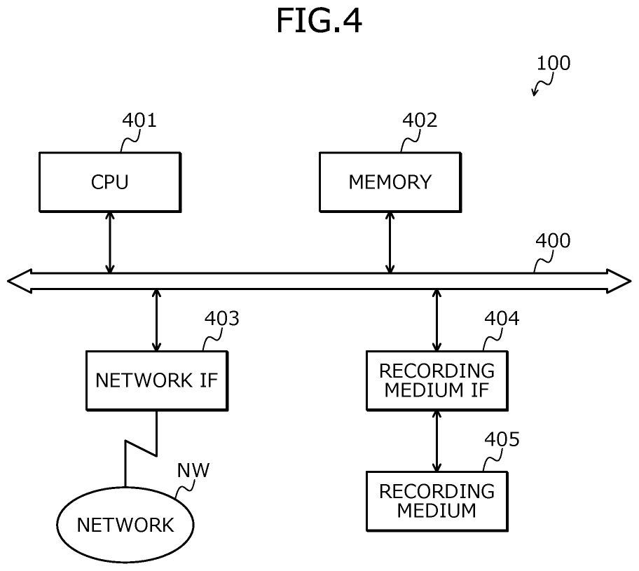

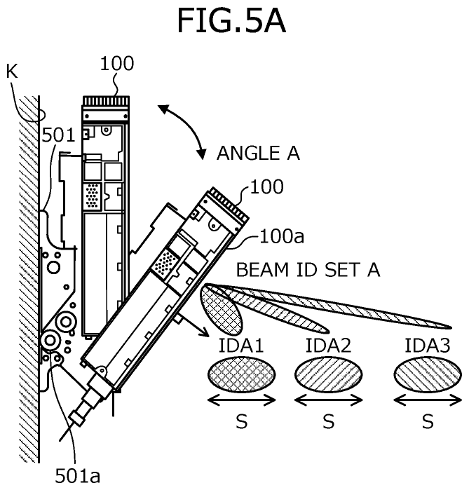

FIG. 4 is a view depicting an example of a hardware configuration related to the beam control of the communication device. Of the communication device 200 depicted in FIG. 3, the configuration (such as the determining unit 305 and the beam ID controller 304) relating mainly to data processing for the beam control may be configured using the general-purpose hardware depicted in FIG. 3.

The communication device 100 includes a central processing unit (CPU) 401, a memory 402, a network interface (IF) 403, a recording medium IF 404, and a recording medium 405. “400” denotes a bus connecting these units.

The CPU 401 is a computing processing device that functions as a controller for overall control of the communication device 100 and the beam control. The memory 402 includes a non-volatile memory and a volatile memory. The non-volatile memory is, for example, a read-only memory (ROM) that stores therein programs of the CPU 401. The volatile memory is, for example, a dynamic random access memory (DRAM) or a static random access memory (SRAM) that is used as a work area of the CPU 401.

The network IF 403 is a communication interface to the network NW such as a local area network (LAN), a wide area network (WAN), or the Internet. The communication device 100 is connected for communication to the network (NW) through the network IF 403. For example, the communication device 100 is connected for communication to the external DU/CU 201 and the external core NW through the FH interface 307 as the network IF.

The recording medium IF 404 is an interface for reading and writing information between the CPU 401 and the recording medium 405, the information being processed by the CPU 401. The recording medium 405 is a recording device supplementing the memory 402, and may be a hard disk drive (HDD), a solid-state drive (SSD), a universal serial bus (USB) flash drive, or the like.

The CPU 401 executes the programs recorded in the memory 402 or the recording medium 405, whereby functions of the communication device 100 are implemented. The memory 402 and the recording medium 405 store and retain therein the information relating to the beam control such as, for example, the beam control information related to the beam widths of the beams radiated by the antenna, for each of the beam IDs that are stored in the memory 306, and the correction information (the beam ID set) for correcting the beam widths for the beam IDs, for each angle.

The hardware configuration depicted in FIG. 4 is similarly applicable as an example of the configuration of the controller of not only the communication device 100 but also each of the terminal 210, the DU/CU 201, and the attitude control device 202.

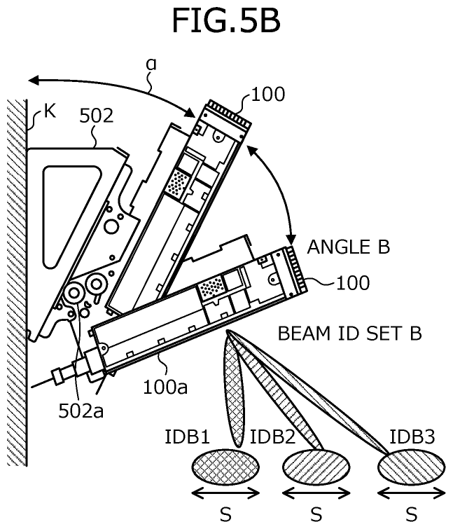

FIGS. 5A and 5B are side views depicting installation examples of the communication device. FIGS. 5A and 5B depict the installation examples of the communication device 100 on the structure K such as a pole or a column. A reference character “100a” denotes the radiation surface of the antenna of the communication device 100.

In the installation example depicted in FIG. 5A, the communication device 100 is fitted to the structure K through a fixture tool 501 on a back face of the communication device 100. As to the structure K that is vertical, the angle of the fixture tool 501 is freely changeable (rotary motion) with respect to the vertical direction (Elevation) as a reference, through a shaft 501a. For example, the installation height on and an angle A of the fixture tool 501 relative to the structure K are set corresponding to the beam IDs of the beams to be projected onto the site. The angle A is a direction from the communication device 100 disposed on the structure K at a high position, to the site (the ground contacting surface) located thereunder. The beam width for each of the beam IDs is different for each installation height and each angle of the communication device 100.

The communication device 100 therefore selects a beam ID set including the beam widths that correspond to the angle A, based on the setting of the height and the angle of the installation. In the installation example in FIG. 5A, the communication device 100 selects a beam ID set A (IDA1, IDA2, and IDA3) that corresponds to the angle A. The communication device 100 uses a direction orthogonal to the radiation surface 100a as the reference and when the beam scanning is executed, radiates the beams of the beam IDs IDA1 to IDA3 of the beam ID set A in directions different from each other in the vertical direction (Elevation).

The communication device 100 selects the beam ID set A that corresponds to the installation state (the angle A) of the communication device 100. All the beams from the wide beam IDA1 directed to a portion of the site located closest to the communication device 100 to the narrow beam IDA3 directed to a portion of the site located farthest from the communication device 100, thereby, each have equal coverage areas S on the site.

In the installation example depicted in FIG. 5B, a fixture tool 502 has an offset angle α in an angular direction, and the angle of the communication device 100 is further freely changeable (rotary motion) to an angle such as, for example, an angle B relative to the offset angle α of the fixture tool as a reference.

For example, in the installation example depicted in FIG. 5B, the communication device 100 selects a beam ID set (IDB1, IDB2, and IDB3) that corresponds to the angle B. The wide beam IDB1 directed to a portion of the site located closest to the communication device 100 may be directed in a substantially vertically downward direction due to “the offset angle α+the angle B” as depicted.

The communication device 100 selects the beam ID set B that corresponds to the installation state (the angle B) of the communication device 100. All the beams from the wide beam IDB1 directed to a portion of the site located closest to the communication device 100 to the narrow beam IDB3 directed to a portion of the site located farthest from the communication device 100 each, thereby, have equal coverage areas S on the site.

In the first configuration example, the attitude detecting sensor 211 in the communication device 100 senses the angle A or B, and the beam ID controller 304 reads the beam ID set that corresponds to the angle A or B from the memory 306 and sets the read beam ID set in the RF front end 301 (BFIC).

In the second configuration example, the attitude control device 202 separate from the communication device 100 controls the angle A or B of the communication device 100. While details are described later, the attitude control device 202 outputs information related to the controlled angle A or B to the DU/CU 201, and the DU/CU 201 selects the beam ID set that corresponds to the angle A or B, and outputs the selected beam ID set to the communication device 100. The communication device 100 reads, from the memory 306, the beam ID set input to the communication device 100 by the DU/CU 201 and sets the read beam ID set in the RF front end 301 (BFIC).

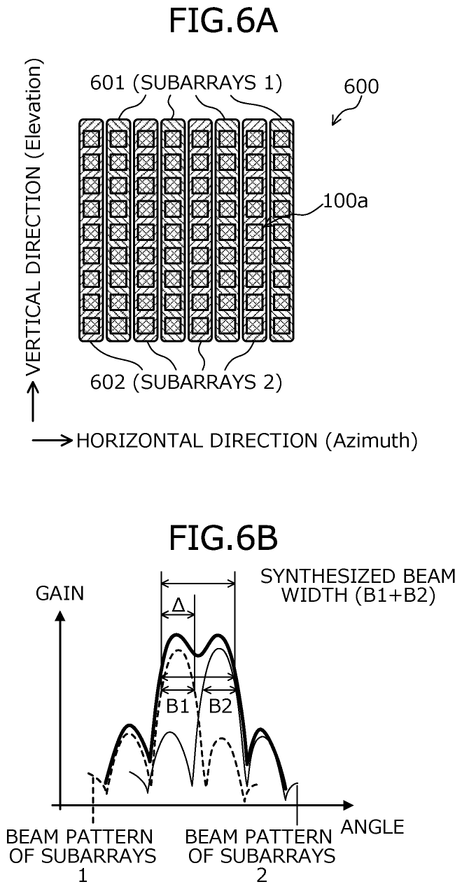

FIG. 6A is a planar view depicting an antenna array of the communication device. The antenna 600 of the communication device 100 has therein plural elements arranged in a matrix-like pattern on the radiation surface 100a. The example depicted in FIGS. 6A and 6B depicts 8×8=64 elements, and the elements are divided into subarrays 1 (601) and subarrays 2 (602) that each include eight elements and that are alternately arranged in the horizontal direction.

FIG. 6B is a view depicting an example of the beam width control of the communication device. The horizontal axis represents the angle, and the vertical axis represents the gain. The antenna 600 depicted in FIG. 6A has different beam patterns depending on the angular direction. The overall beam pattern of the subarrays 2 (602) indicated by a solid line is shifted such that this beam pattern differs in angular direction from the overall beam pattern of the subarrays 1 (601) indicated by a dotted line, said beam pattern differing by an angle A.

The subarrays 1 (601) have a predetermined beam width B1 and the subarrays 2 (602) have a predetermined beam width B2. These beam widths B1 and B2 are at positions different from each other in the angular direction. The communication device 100 may therefore vary the beam width of the overall beam pattern by synthesizing beams of the subarrays 1 and 2. In the depicted example, the beam width becomes B1+B2 indicated by a thick line in FIG. 6B, by synthesizing beams of the subarrays 1 and 2, whereby the beam width may be expanded. The communication device 100 changes the beam width after the synthesis, by adjusting the direction of the beams of the subarrays 1 and 2.

An overview of the control for changing the beam width is described with reference to an example in which the communication device 100 decomposes the beam width into two in the horizontal direction and performs calculation. The communication device 100 breaks down the control into adjustment of the beam width and adjustment of the beam direction to execute processing. In the adjustment of the beam width, as depicted in FIG. 6A, all the elements in the horizontal direction are divided into the two subarrays 1 and 2 each including one half of the elements, and a phase is set so that each of the subarrays 1 and 2 shifts the direction of the beam by a small amount Δ. When Δ is Δ=0, this is equivalent to all the elements of the array being controlled in the same direction. In the adjustment of the beam direction, the phase is offset such that the beams are directed in a desired direction on the site.

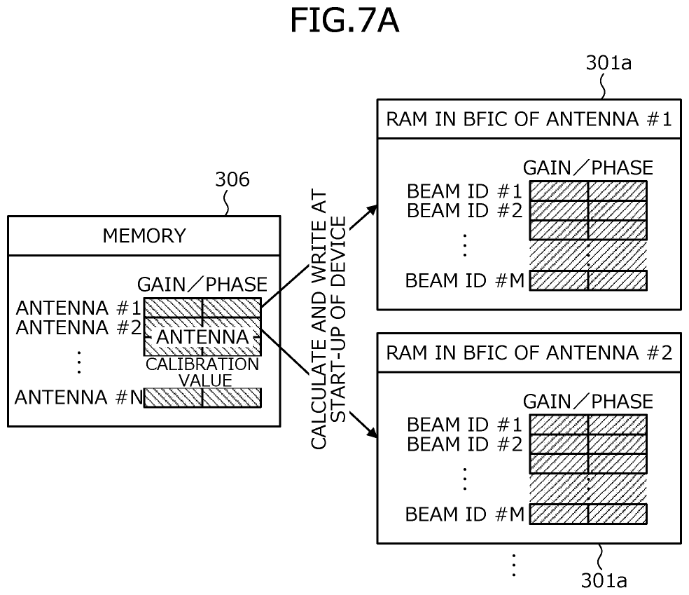

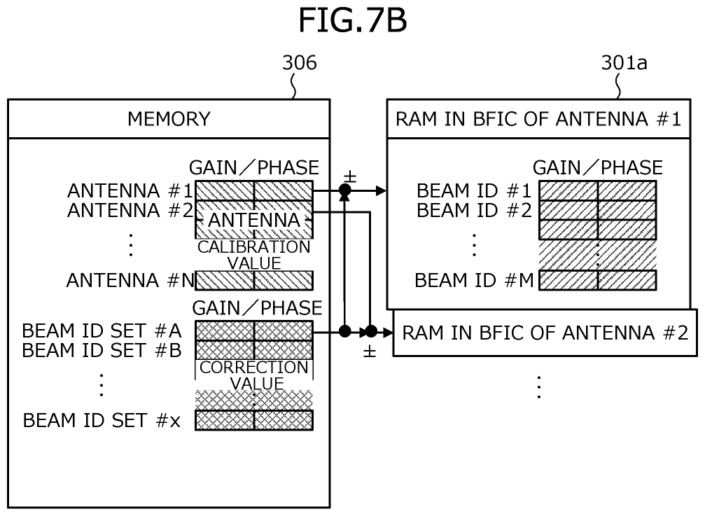

FIGS. 7A and 7B are explanatory views of the information related to the beam control of the communication device. As depicted in FIG. 7A, the memory in the communication device 100 such as, for example, the memory 306 (the non-volatile memory and the like) depicted in FIG. 3 stores therein the calibration values (calibration values) for the elements of the antenna 600. The calibration values include the values of the gain and the phase of the N elements (an antenna #1 to an antenna #N). The number of the elements is, for example, 64 elements as above to 128 elements.

The communication device 100 (the CPU 401) reads the antenna calibration values from the memory 306 when the device is started up, and uses the antennas #1 to #N to calculate the calibration values (the gains and the phases) and form plural beam IDs (#1, and #2 to #M). The number of beam IDs is, for example, 45. The communication device 100 writes the calibration values for the M beam IDs for each of the N antennas into a RAM 301a in the BFIC of the RF front end 301. The communication device 100, during the operation thereof, refers to the RAM 301a and performs beam switching (beam scanning) for each of the beam IDs.

The communication device 100 of the embodiment performs processing of angle correction depicted in FIG. 7B in addition to the calibration described with reference to FIG. 7A. The memory 306 of the communication device 100 stores therein in advance the correction values for each of the beam ID sets in addition to the calibration values for the elements of the antenna 600 similarly to those in FIG. 7A. The correction values for each of the beam ID sets are a beam ID set (#A, and #B to #x) for each angle of the communication device 100 and include the correction values (the gains and the phases) that correspond to each angle.

The communication device 100 (the CPU 401) reads the antenna calibration values and the correction values from the memory 306 when the device is started up. At this time, using the correction values (the gains and the phases) for the beam ID set #x that corresponds to the angle of the installation state of the communication device 100, the communication device 100 performs, for each of the antennas #1 to #N, a calculation process that reflects the correction values on the calibration values (the gains and the phases) for the beam IDs (#1, #2, . . . ).

The communication device 100 writes the calculated setting values into the RAM 301a in the BFIC of the RF front end 301. When the installation state of the communication device 100 changes (when a change of the angle is detected), the communication device 100 updates the information in the RAM 301a in the BFIC, using the corresponding correction values.

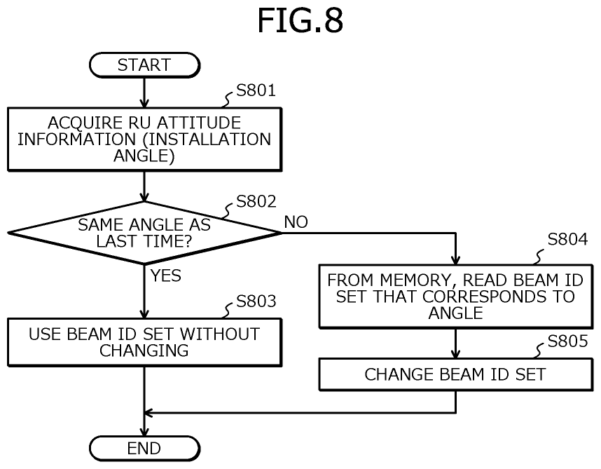

FIG. 8 is a flowchart depicting an example of the beam control of the communication device according to the first embodiment. The example of the beam control using the beam ID set that corresponds to the attitude of the communication device 100 is described with reference to FIG. 8. A beam controller (corresponds to the determining unit 305 and the beam ID controller 304 in FIG. 3) of the communication device 100 and an example of the processing executed by the CPU 401 depicted in FIG. 4 is described below.

The beam controller regularly acquires information related to the attitude of the communication device (RU) 100 (step S801). For example, the beam controller acquires the angle detected by the attitude detecting sensor 211 every 10 minutes. The communication device 100 changes the angle of the beam radiation (the beam ID set) corresponding to the fluctuation of the number of the terminals (the traffic) for the beam IDs 1 to n on the site, according to the date and time of day described above.

Information related to the fluctuation of the number of the terminals (the traffic) may be acquired from a higher-level device such as the DU/CU 201. When the number of the terminals (the traffic) fluctuates, the beam controller may change the beam widths more finely on the basis of the beam ID without being limited to changing the angle of the communication device 100.

The beam controller next determines whether the current attitude (the angle) of the communication device 100 is equal to that acquired in the previous angle detection (step S802). When the result of the determination is that the angle is equal thereto (step S802: YES), the beam controller does not change the previously used beam ID set and uses this beam ID set (step S803) and causes the above processes to come to an end. In this case, the communication device 100 (the beam controller) is at an angle equal to the previously detected angle and thus, communicates with the terminal 210 using the beam widths that are set using the same beam ID set.

On the other hand, when the angle is determined to be different at step S802 (step S802: NO), the beam controller reads, from the memory 306, the beam ID set that corresponds to the currently detected angle (step S804). The beam controller sets the read beam ID set in the RF front end 301 (the BFIC) and thereby, changes the beam ID set (step S805), and causes the above processes to come to an end. In this case, the communication device 100 communicates with the terminal 210 using the beam widths that are set using the beam ID set corresponding to the currently detected angle.

According to the above beam control, every time the angle changes, the communication device 100 uses the beam ID set that corresponds to the angle and may thereby continuously operate maintaining the coverage area of each of the beam IDs 1 to n to be in the same state even when the angle is changed. The communication device 100 changes the angle of the beam radiation corresponding to fluctuations in the number of the terminals accommodated by each of the beam IDs 1 to n on the site according to the date and time of day, and thereby changes the coverage areas of beams corresponding to the beam IDs 1 to n. The number of the terminals 210 accommodated by the beam IDs 1 to n may thereby be equalized among the beam IDs, and reductions in the throughput may be suppressed.

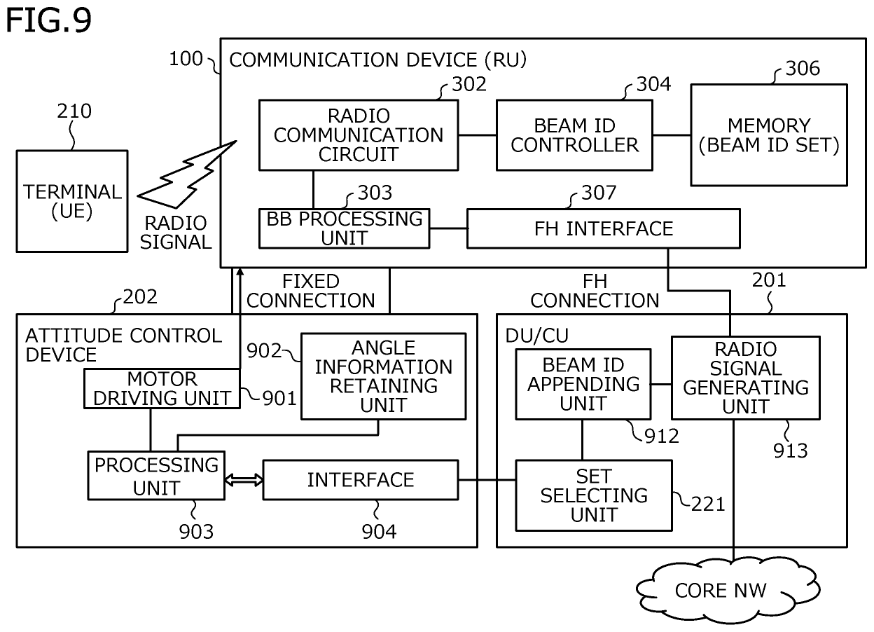

FIG. 9 is a view depicting an example of an overall configuration of the communication system that includes the communication device according to the second embodiment. FIG. 9 depicts internal functions of the communication device 100, the DU/CU 201, and the attitude control device 202 in the second configuration example depicted in FIG. 2. In FIG. 9, functional units similar to those in the first configuration example are given the same reference numerals as in the first configuration example (FIG. 3).

The communication device 100 includes the radio communication circuit 302, the baseband (BB) processing unit 303, the beam ID controller 304, the memory 306, and the FH interface 307.

The radio communication circuit 302 includes the function of the RF front end 301. The radio communication unit 302 performs high frequency (radio) signal processing to execute the radio communication with the terminal 210 through the non-depicted antenna of the communication device 100. The radio communication circuit 302 includes the BFIC that performs radio communication using predetermined beam widths that correspond to the beam ID set input thereto by the beam ID controller 304.

The attitude control device 202 includes functions of a motor driving unit 901, an angle information retaining unit 902, a processing unit 903, and an interface 904. The motor driving unit 901 changes the angle of the communication device 100 by motor-driving the communication device 100. For example, the motor driving unit 901 is disposed on the fixture tools 501 and 502 depicted in FIGS. 5A and 5B and changes the angle of the communication device 100 by motor-driving the communication device 100.

The angle information retaining unit 902 includes a memory, etc. and retains therein angle information of the communication device 100, that corresponds to a motor control amount. The processing unit 903 outputs, to the motor driving unit 901, information related to the motor control amount according to an instruction to change the attitude and thereby changes the angle of the communication device 100. At this time, the processing unit 903 reads the angle information that corresponds to the motor control amount from the angle information retaining unit 902 and outputs the angle information to the DU/CU 201 through the interface 904.

The DU/CU 201 includes the functions of the beam ID set selecting unit 221, a beam ID appending unit 912, and a radio signal generating unit 913. The beam ID set selecting unit 221 includes a memory, etc. that retain therein the beam ID sets for each angle of the communication device 100. The beam ID set selecting unit 221 reads, from the memory, the beam ID set that corresponds to the angle information output from the attitude control device 202, and outputs the read beam ID set to the beam ID appending unit 912.

The radio signal generating unit 913 generates a radio signal and is communicably connected to the core NW and the communication device 100. The beam ID appending unit 912 appends, to the radio signal, information related to the beam ID set selected by the beam ID set selecting unit 221. The information related to the beam ID set corresponding to the angle of the communication device 100 is thereby transmitted to the communication device 100.

Due to the above configuration, the information related to the beam ID set corresponding to the angle of the communication device 100 changed by the attitude control device 202 using the motor driving is input into the communication device 100 from the DU/CU 201. The radio communication circuit 302 of the communication device 100 performs radio communication (and radio communication based on the data input and output by the FH interface 307) with the terminal 210. When the radio communication is executed, the radio communication circuit 302, using the beam ID set that corresponds to the angle of the communication device 100, performs the beam width control so that the coverage areas associated with the beam IDs are set to be constant.

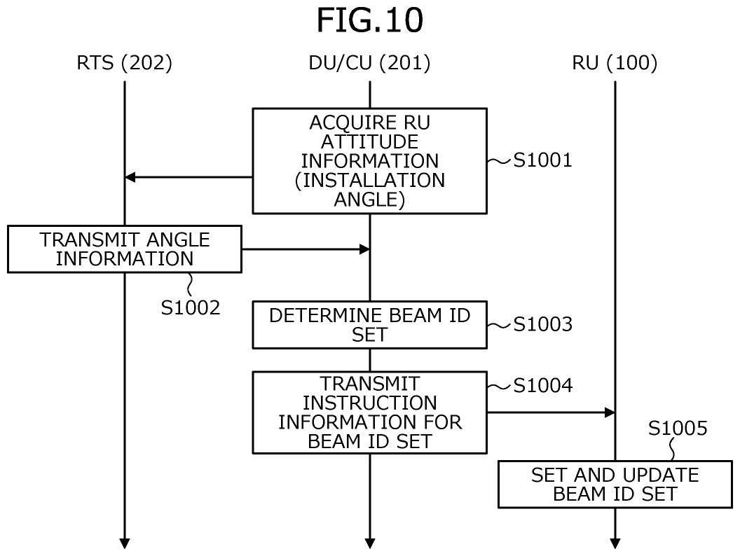

FIG. 10 is a sequence diagram depicting an example of the beam control of the communication device according to the second embodiment. An example of the beam control corresponding to the communication device 100, the DU/CU 201, and the attitude control device 202 depicted in FIG. 9 is described.

The DU/CU 201 acquires information related to the attitude of the communication device (RU) 100, from the attitude control device 202 (step S1001). For example, the DU/CU 201 regularly (such as, for example, every 10 minutes) requests the information related to the attitude from the attitude control device 202. The attitude control device 202 transmits the information related to the angle of the communication device 100 set by the motor driving to the DU/CU 201 at each request (step S1002).

The DU/CU 201 next determines the beam ID set that corresponds to the current angle of the communication device 100, transmitted from the attitude control device 202 (step S1003). The DU/CU 201 transmits instruction information that indicates the determined beam ID set, to the communication device 100 (step S1004).

The communication device 100 sets the beam ID set in the instruction information received from the DU/CU 201, in the radio communication circuit 302 (the BFIC) and thereby updates the setting of the beam ID set (step S1005). As a result, the communication device 100 communicates with the terminal 210, using the beam widths set using the beam ID set that corresponds to the current angle of the communication device 100.

In the above example of the beam control, the attitude of the communication device 100 is controlled by changing the angle thereof by the attitude control device 202 of an external device, and the DU/CU 201 outputs, to the communication device 100 as an instruction, the information related to the beam ID set that corresponds to the angle. In this example of the control, the communication device 100 also uses the beam ID set that corresponds to the angle each time the angle changes and thereby may continuously operate in a state where the coverage areas of beams associated with the beam IDs 1 to n are equal to each other even when the angle is changed. The communication device 100 changes the angle of the beam radiation corresponding to fluctuations or the like of the number of the terminals accommodated by each of the beams associated with the beam IDs 1 to n on the site, according to the date and time of day and thereby, changes the coverage areas associated with the plural beam IDs 1 to n. The number of the terminals 210 accommodated by the beam IDs 1 to n may thereby be equalized among the beam IDs, and degradation of the throughput may be suppressed.

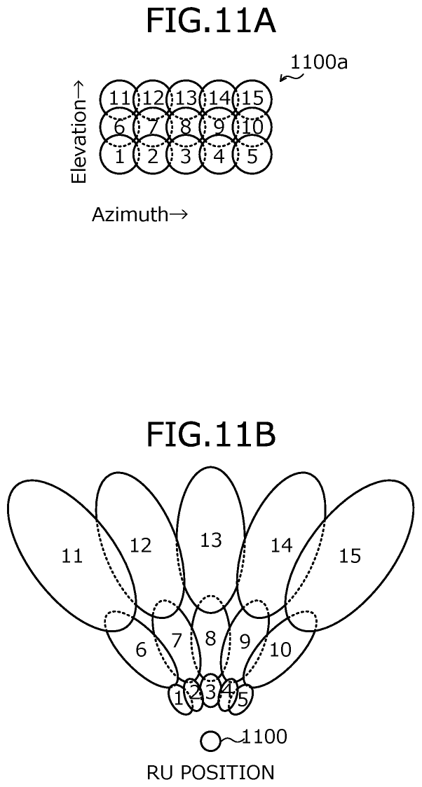

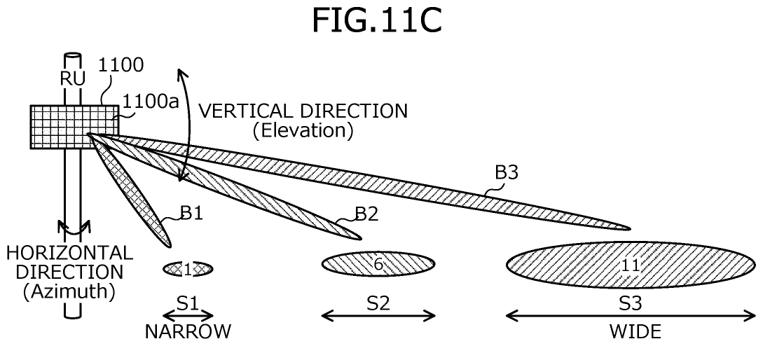

FIGS. 11A, 11B, 11C are explanatory views of the coverage areas of a conventional communication device for comparison. FIG. 11A is a view depicting beams associated with beam IDs and radiated from a radiation surface 1100a of an antenna of the conventional communication device 1100. FIG. 11B is a view depicting the coverage areas of beams associated with the beam IDs on the site. FIG. 11C is a side view depicting an installation state of the communication device 1100.

As depicted in FIG. 11A, as to the conventional communication device 1100, the beam widths of the beams associated with the n beam IDs 1 to n and radiated from the radiation surface 1100a are equal to one another and are at regular intervals in each of the horizontal direction (Azimuth) and the vertical direction (Elevation).

In this case, as depicted in FIGS. 11B and 11C, the coverage areas of beams associated with the beam IDs and projected onto the site differ from one another. For example, a coverage area S1 of the beam associated with the beam ID 1 is located closest to the communication device 1100 and is narrow while a coverage area S3 of the beam associated with the beam ID 11 and located farthest from the communication device 1100 is wide. In this manner, as to the existing communication device 1100, the coverage areas of the beams associated with the n beam IDs differ from one another and are not equal to one another, and a problem of degradation of the throughput as above is present.

In contrast, as depicted in FIGS. 1A, 1B, and 1C, the communication device 100 of the embodiments variably controls the beam widths B of the beams radiated from the communication device 100 and thereby equalizes, among the beam IDs 1 to n, the coverage areas S of beams that are associated with the beam IDs and projected onto the site. The communication device 100 retains therein the plural, that is, the n beam IDs as the beam ID set for each angle (corresponds to “each distance”) from the communication device 100, and performs the control for the beam widths B using the beam ID set that corresponds to the angle of the communication device 100.

The coverage areas S of the beams associated with the beam IDs are equalized on the site and the number of the terminals accommodated in the coverage areas of the beams associated with the beam IDs 1 to n may thereby be equalized among the beam IDs, and degradation of the throughput may be suppressed.

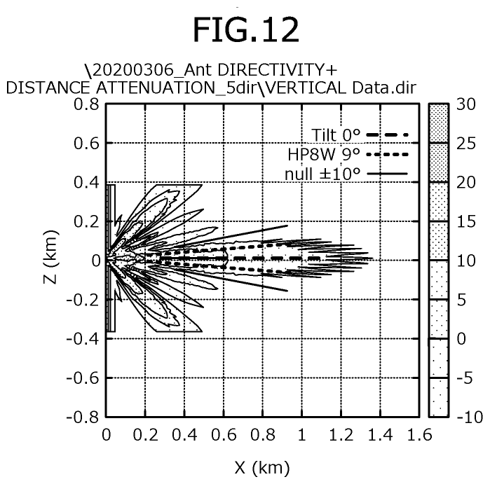

FIG. 12 is a view depicting an example of actual beam projection shapes. In the above description, the coverage areas on the site are each depicted as an ellipse for convenience in FIGS. 1A, 1B, and 1C, FIGS. 11A, 11B, 11C, etc. As depicted in FIG. 12, the actual coverage areas on the site form a substantially fan-like shape in which the coverage areas of the beams associated with the beam IDs 1 to n spread radially centered about the communication device (RU) 100, each of the coverage areas of the beams associated with the beam IDs having a shape with opposite sides that are each substantially linear.

According to the above embodiments, the communication device 100 performs beamforming for the beam IDs and performs radio communication with terminals located on the site, and includes the storage unit that stores therein the beam control information related to the beam width of the beam radiated from the antenna, for each of the beam IDs, and the beam controller (such as the beam ID controller 304) that performs the beam control using the beam width for each of the beam IDs, based on the beam control information. The coverage areas of beams associated with the beam IDs and projected onto the site may thereby be dynamically changed. For example, the widths of the beams associated with the beam IDs are changed corresponding to traffic fluctuations occurring when the number of the terminals positioned in each of the coverage areas of beams associated with the beam IDs fluctuates according to the date and time of day, and the number of the accommodated terminals by beams of the beam IDs may thereby be equalized among the beam IDs, and the throughput may be improved.

In the communication device 100, the beam controller performs the control of equalizing, among the beam IDs, the coverage areas of beams associated with the beam IDs and projected onto the site, by increasing the beam width of a beam associated with a beam ID and projected onto a portion of the site located close to the communication device 100 and decreasing the beam width of a beam projected onto a portion of the site located farther from the communication device 100, based on the installation conditions (such as the height and the angle) of the communication device 100. In this manner, in the configuration for the communication device to obliquely radiate the beams toward the site, at angles from a high place, the coverage areas of beams associated with the beam IDs for each distance may be equalized among the beam IDs, compensating for the projected coverage area being wider for a beam ID of a beam whose distance from the communication device is relatively farther.

In the communication device 100, the beam controller performs the control for the beam width for the vertical direction, among the vertical direction and the horizontal direction of the beam widths. In this manner, in the configuration for the communication device to obliquely radiate the beams toward the site, at angles from a high place, the beam width in the vertical direction is controlled, compensating for the projected coverage area being wider for a beam ID of a beam whose distance from the communication device is relatively farther, and the coverage areas of beams associated with the beam IDs and projected onto the site may thereby be equalized among the beam IDs.

In the communication device 100, the beam controller may execute control of equalizing, among the beam IDs, the power in the coverage areas of beams associated with the beam IDs by reducing the transmission power of a beam associated with a beam ID and projected onto a portion of the site located close to the communication device 100 and increasing the transmission power of the beam associated with a beam ID and projected onto a portion of the site located farther from the communication device 100, for the vertical direction, among the vertical direction and the horizontal direction of the beam width. The power for the plural beam IDs may thereby be equalized among the beam IDs, and improvement of the throughput may be facilitated.

In the communication device 100, the beam controller stores and retains in the storage unit, the correction information (the beam ID sets) for correcting the widths of beams associated with the beam IDs, for each angle as the control information, selects the beam ID set that corresponds to the detected angle of the communication device 100, and controls the beam widths. The beam widths of beams associated with the beam IDs are thereby controlled and the coverage areas may be equalized among the beam IDs by reading the beam IDs that correspond to the angle, among the beam IDs stored and retained in the memory in advance.

The communication device 100 may include a sensor that detects the angle of the communication device 100. In this case, the beam controller selects the correction information (the beam ID set) that corresponds to the detected angle of the communication device 100 and controls the beam widths. The communication device may thereby autonomously detect the angle and may control the beam widths.

The communication device 100 may also have a configuration for the angle of the communication device 100 to be freely changeable and controlled by the attitude control device. In this case, the beam controller selects the control information that corresponds to the angle of the communication device 100, based on the information related to the angle changed by the attitude control device, and controls the beam widths. The communication device may thereby control the beam widths corresponding to the angle changed by the motor driving or the like of the attitude control device. A configuration may also be combined according to which the attitude control device changes and controls the angle of the communication device and the communication device detects the angle using a sensor.

A configuration may also be employed according to which the above attitude control device transmits the information related to the angle to the DU or the CU, and the beam controller of the communication device 100 controls the beam widths, based on the correction information (the beam ID set) that corresponds to the angle of the communication device 100 selected by the DU or the CU. The communication device may thereby receive the information related to the angle through a higher-level device such as the DU or the CU connected to the communication device in the communication system and execute the beam control corresponding to the angle.

The communication device 100 may also acquire the angle of the communication device 100 at predetermined times, select the correction information (the beam ID set) that corresponds to the angle after being changed when the angle is changed, and control the beam widths. The number of the terminals accommodated in the coverage areas of the beams associated with the beam IDs may be equalized among the beam IDs by varying the coverage area by changing the angle corresponding to fluctuations in the number of the accommodated terminals for each of the beam IDs, the fluctuations being due to, for example, the elapse of time such as days, time, etc.

In the communication device 100, the beam controller may also execute control of changing the angle corresponding to traffic fluctuations on the site for the plural beam IDs. For example, the communication device may equalize, among the beam IDs, the number of the terminals for the plural beam IDs by changing the beam widths of beams associated with the beam IDs, corresponding to the angle, through an instruction from a higher-level device.

The communication device 100 may further execute control for the beam controller to change the beam width for each of the beam IDs, corresponding to traffic fluctuations for the plural beam IDs on the site. For example, the communication device may equalize, among the beam IDs, the number of the terminals for each of the plural beam IDs, by changing the beam width of the beams associated with the beam IDs, through an instruction from a higher-level device.

From the above, according to the embodiments, in the configuration for the communication device to project beams of plural beam IDs onto the site and communicate with a terminal on the site, the coverage area of each of the beams after being projected onto the site may be set to be an appropriate coverage area by controlling the beam width of each of the beams associated with the beam IDs. For example, the communication device equalizes, among the beam IDs, the coverage areas of beams associated with the beam IDs and may change only the coverage areas of some of beams associated with the beam IDs, by actively changing the coverage areas. The change of the coverage areas may cope with a concentration of the terminals at a specific beam ID, may suppress frequent switching among the beam IDs caused by movement of the terminals, and may suppress concurrent connection of many terminals at a specific beam ID, and improvement of the throughput may be facilitated.

The communication method described in the present embodiment may be implemented by executing a prepared program on a processor such as a server. The method is stored on a non-transitory, computer-readable recording medium such as a hard disk, a flexible disk, a compact-disk read-only memory (CD-ROM), a Digital Versatile Disk (DVD), and a flash memory, read out from the computer-readable medium, and executed by a computer. The method may be distributed through a network such as the Internet.

According to an aspect of the present invention, an effect is achieved that an appropriate coverage area may be established on a site for each beam ID.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication device configured to form a plurality of beams for a plurality of beam IDs and communicate by radio with a terminal located on a site, the communication device comprising:
a storage unit that stores therein beam control information related to a beam width of each of the plurality of beams radiated for each of the beam IDs from an antenna; and
a beam controller configured to perform beam control by the beam width for each of the beam IDs, based on the beam control information.

2. The communication device according to claim 1, wherein
the beam controller performs control of equalizing coverage areas of the plurality of beams associated with the plurality of beam IDs and projected onto the site, the beam controller performing the control, based on installation conditions of the communication device, by increasing the beam width of a beam projected close to the communication device and relatively decreasing the beam width of a beam the farther the beam is projected from the communication device.

3. The communication device according to claim 2, wherein
of a vertical direction and a horizontal direction of the beam width, the beam controller performs control of the beam width in the vertical direction.

4. The communication device according to claim 2, wherein
the beam controller performs control of equalizing powers in the coverage areas by reducing a transmission power of a beam projected close to the communication device and relatively increasing a transmission power of a beam the farther the beam is projected from the communication device in a vertical direction, among the vertical direction and a horizontal direction of the beam width.

5. The communication device according to claim 1, wherein
the beam controller stores and retains as the control information, in the storage unit, correction information for correcting the beam width for each of beam IDs, for each angle of the communication device, and selects the correction information that corresponds to a detected angle of the communication device, to thereby control the beam width.

6. The communication device according to claim 5, further comprising:
a sensor that detects the angle of the communication device, wherein
the beam controller selects the correction information that corresponds to the detected angle of the communication device to thereby control the beam width.

7. The communication device according to claim 5, wherein
the angle of the communication device is freely changeable and controlled by an attitude control device, and
the beam controller selects the control information that corresponds to the angle of the communication device, based on information related to the angle changed by the attitude control device, and thereby controls the beam width.

8. The communication device according to claim 7, wherein
the attitude control device transmits the information related to the angle to a distributed unit (DU) or a central unit (CU), and
the beam controller of the communication device controls the beam width, based on the correction information that corresponds to an angle of the communication device, the angle being selected by the DU or the CU.

9. The communication device according to claim 5, wherein
the beam controller acquires the angle of the communication device at each predetermined time interval and, when the angle has changed, selects the correction information that corresponds to the changed angle, and thereby controls the beam width.

10. The communication device according to claim 2, wherein
the beam controller performs control of changing the angle according to a fluctuation of traffic of the plurality of beam IDs, occurring on the site.

11. The communication device according to claim 1, wherein
the beam controller performs control of changing the beam width for each of the beam IDs, according to a fluctuation of traffic of the plurality of beam IDs, occurring on the site.

12. A communication method executed by a computer, for a communication device configured to form a plurality of beams for a plurality of beam IDs and communicate by radio with a terminal located on a site, the method comprising:
storing, to a storage unit, beam control information related to a beam width of each of the plurality of beams radiated for each of the beam IDs from an antenna; and
performing beam control by the beam width for each of the beam IDs, based on the beam control information.

13. The communication method according to claim 12, comprising:
performing control of equalizing coverage areas of the plurality of beams associated with the plurality of beam IDs and projected onto the site, the beam controller performing the control, based on installation conditions of the communication device, by increasing the beam width of a beam projected close to the communication device and relatively decreasing the beam width of a beam the farther the beam is projected from the communication device.
